(19) United States
(12) Patent Application Publication
(10) Pub. No.: US 2003/0201977 A1
(43) Pub. Date: Oct. 30, 2003

(54) Computer mouse with integral keypad

(76) Inventors: Alan C. Hassig, Long Beach, NY (US); Bruno Polito, Baldwin, NY (US)

Correspondence Address: BRUNO POLITO, 2841 TULIP AVENUE, BALDWIN, NY, 11510, US

(21) Appl. No.: 10/135,549

(22) Filed: Apr. 30, 2002

(51) Int. Cl. G09G 5/08

(52) U.S. Cl. 345/163

(57) ABSTRACT

A computer mouse having an integral numeric keypad. The key pad is located proximate the upper surface of the mouse so that the user can position the combination mouse-keypad with a hand while being able to rapidly access the numeric keypad through a slight movement of the same hand.

### FIELD OF THE INVENTION

This invention relates to computer peripherals, and more particularly to computer input devices.

### BACKGROUND OF THE INVENTION

The utility of computers has made them an invaluable office tool and desirable home device. The number of applications for which computers are currently being used is legion, and the number of prospective applications seems limitless. Thus, greater numbers of people find themselves using computers on an ever increasing basis. Therefore, any device or technique that can improve the efficiency of people's work with computers would benefit a great number of people.

### SUMMARY OF THE INVENTION

It has been recognized that one way in which user interaction with computers can be improved is by providing a combination mouse-keypad computer input device. Accordingly, the present invention provides a computer mouse having an integral numeric keypad. The key pad is located proximate the upper surface of the mouse so that the user can position the combination mouse-keypad with a hand while being able to rapidly access the numeric keypad through a slight movement of the same hand.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 shows a top view of a combination mouse-keypad device in accordance with the present invention; and

FIG. 2 shows a side view of a combination mouse-keypad device in accordance with the present invention.

### DETAILED DESCRIPTION OF CERTAIN PREFERRED EMBODIMENTS

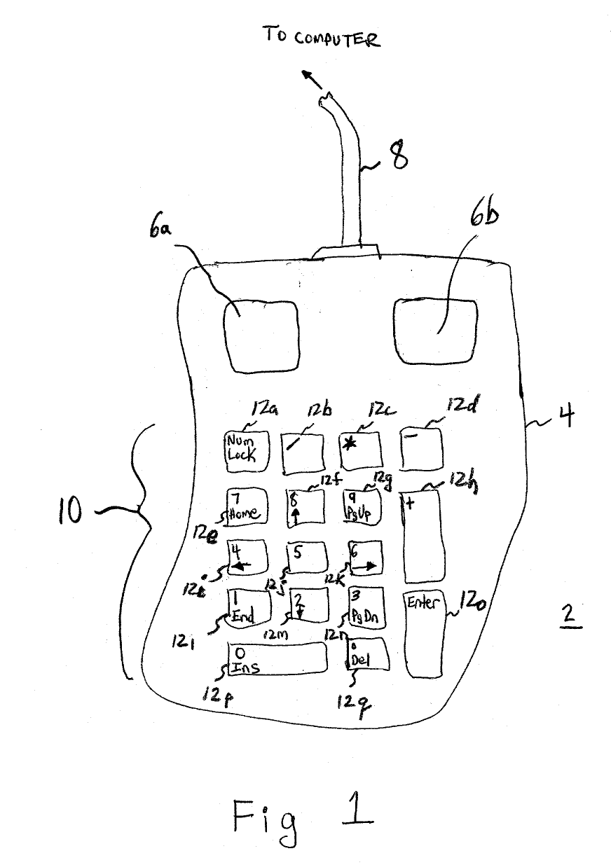

FIG. 1 shows a top view of a combination mouse-keypad device 2 (hereinafter “mouse”) in accordance with a preferred embodiment of the invention. As can be seen from FIG. 1, the mouse includes a housing 4, function buttons 6a and 6b, and a multiple of additional keys indicated generally by reference numeral 10. A cable 8 couples the mouse to a computer (not shown).

In general, a user of the mouse positions the mouse on a flat surface and moves the mouse by grasping the housing with a hand and sliding the mouse across the surface. The movements of the mouse in the X-Y plane defined by the surface are monitored through a track-ball located on the underside of the mouse, the track ball being in contact with both the surface and the mouse. The movements of the mouse are translated into pointer icon movements such that the user controls the movement of the pointer via the mouse. In other words, the movement of the pointer in the X-Y plane defined by the computer display screen corresponds to the movement of the mouse in the X-Y plane defined by the surface on which the mouse rests. Of course, one skilled in the art will be aware of many alternative techniques for associating mouse movement with pointer movement.

The function buttons 6a and 6b initiate functions based on the position of the pointer icon. For example, in the WINDOWS operating system Desktop, the pointer may be positioned over an application program icon and the application may be invoked by depressing program button 6a twice in rapid succession, that is by “double clicking” with button 6a. In addition, when the pointer is positioned over an application program icon and button 6b is depressed once, a list of operations which may be performed on the icon is provided, two such options including, for instance, “copy” and “delete.”

In any event, the signals generated to monitor movement of the track ball and to indicate the depressing of buttons 6a and 6b are relayed to the computer through cable 8. The cable may include one or more signal carrying couplings, each coupling taking one or more of several forms, such as coaxial cable, twisted-pair wiring, fiber optic lines and the like. As an alternative, one or more wireless links may be used to relay the signals to the computer.

The mouse of FIG. 1 also includes a multiple of additional keys, generally indicated at 10. In a preferred embodiment, the additional keys include the keys illustrated in FIG. 1. Namely, the additional keys include: a “Num Lock” key 12a; a“/” key 12b; a “*” key 12c; a “−” key 12d; a “7,Home” key 12e; a “8,up” key 12f; a “9,PgUp” key 12g; a “+” key 12h; a “4,left” key 12i; a “5” key 12j; a “6,right” key 12k; a “1,End” key 12l; a “2,down” key 12m; a “3,PgDn” key 12n; an “Enter” key 12o; a “0,Ins” key 12p and a “.,Del” key 12q. In a preferred embodiment, the respective functions of these keys is the same as the functions of their namesake keys in the standard IBM 101 and 102 key keyboards. In alternative embodiments, the respective functions of the additional keys may vary from the functions of their namesake keys in the standard IBM 101 and 102 key keyboards. For example, another set of keys sufficient for numerical entry may be provided as an alternative to keys 10. In any event, coupling of additional keys 10 to the computer can be accomplished in the same manner as the coupling of buttons 6a and 6b to the computer; namely through cable 8.

It has been recognized that many of the tasks performed on a computer involve moving the mouse so that the pointer icon is positioned at a particular point on the computer display screen and then entering information via the computer's keyboard. An example of such an operation is the operation of entering information into a spreadsheet program such as MICROSOFT EXCEL. Typically, a user of EXCEL positions the pointer at a desired cell within a spreadsheet page and then enters a number into the cell by using the numeric keypad on the computer's keyboard. In practice, a user of a spreadsheet program uses his/her favored hand (right hand for most people) to position the mouse so as to access the appropriate cell and then moves his/her hand to the numeric keys on the computer's keyboard to enter a number. Thereby, requiring the user to entirely reposition his/her hand each time a new cell is accessed. Usually, this operation is repeated many times during the course of a spreadsheet program session, and becomes particularly cumbersome when a user is trying to make a large number of entries in the shortest time possible.

By providing a combined mouse and a numeric keypad, the present invention relieves the user of the need to entirely reposition his/her hand after each cell entry. Rather, when the invention is employed in a spreadsheet context a user can move the mouse with a hand (for example the user's favored hand), use the keypad on the mouse to enter a number, and then move the mouse to a new position, all without removing his/her hand from the mouse. The user needs only to make a minimal adjustment to his/her hand position to switch between mouse movement and numeric keypad entry. In view of the efficiency of using the mouse of the invention in conjunction with spreadsheet software, one may appropriately refer to the invention as “the accountant's mouse.”

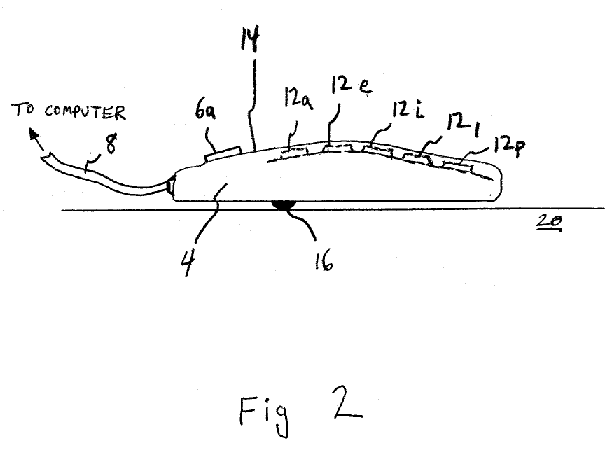

FIG. 2 shows a side view of a the mouse of FIG. 1. Since the diagram is in profile, clarity of presentation dictates that only the positions of additional keys 12a, 12e, 12i, 12l and 12p are shown (in phantom). The positions of the remaining additional keys may be inferred. Also visible in FIG. 2 is a track ball 16, as described above. The mouse is wresting on a surface 20.

As can be seen from FIG. 2, the top surface (that is the “touch surface”) of each of the additional keys lies beneath an upper surface 14 of housing 4. The keys are accessed through access holes provided in upper surface 14. This configuration is preferred because it helps to prevent accidental pressing of one of the additional keys when a user intends to move the mouse without depressing one or more of the additional keys. Of course it is not necessary for the additional keys to be recessed below surface 14 and the touch surfaces of the additional keys may protrude from surface 14.

While the present invention has been particularly shown and described in conjunction with preferred embodiments thereof, it will be readily appreciated by those of ordinary skill in the art that various changes may be made without departing from the spirit and scope of the invention. Therefore, it is intended that the appended claims be interpreted as including the embodiments described herein as well as all equivalents thereto.

What is claimed is:

1. A computer mouse, comprising:
a housing; and
a numeric keypad including a plurality of keys and being proximate an upper surface of said housing.

2. A computer mouse as set forth in claim 1, wherein said upper surface of said housing includes one or more access holes, and one or more of said numeric keys is positioned below said upper surface and is/are accessible through said one or more access holes.

3. A computer mouse as set forth in claim 1, wherein said plurality of keys includes number keys 0, 1, 2, 3, 4, 5, 6, 7, 8 and 9.

4. A computer mouse as set forth in claim 3, wherein said plurality of keys includes an “enter” key.

5. A computer mouse as set forth in claim 3, wherein said plurality of keys includes a “plus” key.

6. A computer mouse as set forth in claim 3, wherein said plurality of keys includes arithmetic function keys “plus,” “minus,” “divide” and “multiply.”

7. A computer mouse as set forth in claim 3, wherein said plurality of keys includes a “page-up” key and a “page-down” key.

8. A computer mouse as set forth in claim 3, wherein said plurality of keys includes an “insert key” and a “delete key.”

9. A computer mouse as set forth in claim 1, wherein said plurality of keys includes number keys 0, 1, 2, 3, 4, 5, 6, 7, 8 and 9, an “enter” key, arithmetic function keys “plus,” “minus,” “divide” and “multiply,” a “page-up” key, a “page-down” key, an “insert key” and a “delete key.”

10. A computer mouse as set forth in claim 1, wherein said plurality of keys includes a “Num Lock” key; a “/” key; a “*” key; a “−” key; a “7,Home” key; a “8,up” key; a “9,PgUp” key; a “+” key; a “4,left” key; a “5” key; a “6,right” key; a “1,End” key; a “2,down” key; a “3,PgDn” key; an “Enter” key; a “0,Ins” key and a “.,Del” key.

11. A computer mouse as set forth in claim 1, further comprising a track ball.

12. A computer mouse as set forth in claim 1, further comprising one or more function buttons.

13. A computer mouse as set forth in claim 1, wherein a user of said mouse can, immediately following positioning of said mouse, access said plurality of keys by a slight adjustment of hand position.

14. A computer mouse with integral keypad, comprising:
a housing; and
a numeric keypad including a plurality of keys and being proximate an upper surface of said housing.

15. A computer mouse with integral keypad as set forth in claim 14, wherein said upper surface of said housing includes one or more access holes, and one or more of said numeric keys is positioned below said upper surface and is/are accessible through said one or more access holes.

16. A computer mouse with integral keypad s set forth in claim 14, wherein said plurality of keys includes number keys 0, 1, 2, 3, 4, 5, 6, 7, 8 and 9.

17. A computer mouse with integral keypad as set forth in claim 16, wherein said plurality of keys includes an “enter” key.

18. A computer mouse with integral keypad as set forth in claim 16, wherein said plurality of keys includes a “plus” key.

19. A computer mouse with integral keypad as set forth in claim 16, wherein said plurality of keys includes arithmetic function keys “plus,” “minus,” “divide” and “multiply.”

20. A computer mouse with integral keypad as set forth in claim 14, wherein a user of said mouse an, immediately following positioning of said mouse, access said plurality of keys by a slight adjustment of hand position.
